(19) United States
(12) Patent Application Publication
(10) Pub. No.: US 2006/0150208 A1
(43) Pub. Date: Jul. 6, 2006

(54) Tray door guiding mechanism for optical disc device

(75) Inventor: Wu Jen Lo, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/080,459

(22) Filed: Mar. 16, 2005

(30) Foreign Application Priority Data
Dec. 31, 2004 (TW) 093141757

(51) Int. Cl. G11B 17/03; G11B 17/04; G11B 33/02

(52) U.S. Cl. 720/613

(57) ABSTRACT

The present invention relates to a tray door guiding mechanism for optical disc device. The optical disc device has a disc tray, and the tray door guiding mechanism includes a front panel having a tray in-out window for allowing the tray to carry into/out from the optical disc device, in which at least one side of the tray in-out window is provided with a guiding trench; a tray door provided in front of the disc tray, in which at least one side of the tray door is provided with a guiding rib; wherein the guiding rib is exactly guided in the guiding trench when the tray is carried in the optical disc device. According to the present tray door guiding mechanism for optical disk device, it is possible to exactly guide the tray door into the device before the tray door is carried in the device, thereby it is possible to avoid the occurrence of interference caused by the step difference between the tray door and the front panel and to control the gap between the tray door and the front panel in a desired range.

This Non-provisional application claims priority under 35 U.S.C. §119(a) on Patent Application No(s). 093141757 filed in Taiwan, Republic of China on Dec. 31, 2004, the entire contents of which are thereby incorporated by reference.

### FIELD OF THE INVENTION

The present invention relates to a tray door guiding mechanism for optical disc device, particularly to a tray door guiding mechanism for optical disc device which guides the tray door before the tray door inserts into the front panel of the optical disc device.

### BACKGROUND OF THE INVENTION

Optical disc devices based on their disc carrying manners could be classified into cover-lifting type, slot-in type, single-disc type, and multi-disc type optical disc devices. Among them, the single-disc type optical disc device mainly includes a tray for carrying the disc and a tray door provided in front of the tray for providing dust-proof and ornamental functions. On the outer surface of the tray door, a decorative panel is optionally provided. Carrying the disc tray into/out from the optical disc device is normally performed by electric-mechanical action.

As mentioned above, the tray door provides an ornamental function in addition to the dust-proof function, thus a stage difference between the tray door and the front panel of the optical disc device should be prevented. To meet a good quality requirement, the gap between the tray door and the front panel of the optical disc device is also required as small as possible. But during assembling optical disc devices, occurrence of assembling error is incidental, which results in relative stage error between the front panel position and the tray door position. Due to such relative stage error, a stage difference interference between the tray door and the front panel will occur or an uneven gap between them is found.

In the current optical disc devices, a simple mechanism for guiding disc tray is provided. However, such a guiding mechanism starts to guide the disc tray when the tray door arrives at the front panel. In this time, a stage difference between the tray door and the front panel has been already occurred. Thus it also encounters problems of non-planar surface between the tray door and the front panel and a large or uneven gap between them.

In view of the above problems, the present inventor has conducted an investigation on the disc tray structure of optical disc device and thus completed this invention.

### SUMMARY OF THE INVENTION

The object of the present invention is to provide a tray door guiding mechanism for optical disc device, which uses a simple guiding mechanism to eliminate the relative stage error between a tray door and a front panel of the optical disc device. Accordingly, the tray door guiding mechanism of the present invention will start to exactly guide the tray door before entering it into the optical disc device completely to avoid the occurrence of stage difference interference between the tray door and the front panel. Additionally, it is easy to control the gap between the tray door and the front panel in a desired range.

According to the above objects, the present invention provides a tray door guiding mechanism for optical disc device having a disc tray for carrying the disc, the tray door guiding mechanism includes: a front panel and a tray door, in which the front panel is provided with a tray in-out window for allowing the tray to carry into/out from the optical disc device, at least one side of the tray in-out window is provided with a guiding trench; the tray door is provided in front of the disc tray, at least one side of the tray door is provided with a guiding rib; wherein the guiding rib is exactly guided in the guiding trench when the tray is carried into the optical disc device.

### BRIEF DESCRIPTION OF DRAWINGS

The present invention is illustrated more detail by reference to the accompanying drawings, wherein:

FIG. 1 is a perspective view showing one embodiment of the tray door guiding mechanism for optical disc device according to the present invention;

FIG. 2a is a side sectional view showing the tray door guiding mechanism shown in FIG. 1;

FIG. 2b is a top sectional view partially showing the tray door guiding mechanism shown in FIG. 1;

FIG. 3a is a top sectional view partially showing the tray door guiding mechanism shown in FIG. 1;

FIG. 3b is a side sectional view partially showing the tray door guiding mechanism shown in FIG. 1;

FIGS. 4a-4e are flow charts showing the tray door guiding mechanism of the present invention how to guide the tray door; and

FIG. 5 is a perspective view showing another embodiment of the tray door guiding mechanism for optical disc device according to the present invention.

### DETAILED DESCRIPTION OF THE INVENTION

The present invention is illustrated in more detail by reference the following examples which are only used for illustration without limiting the scope of the present invention.

In the following examples, the left and right sides of the tray door are each provided with a guiding rib and the left and right sides of the tray in-out window are each correspondingly provided with a guiding trench.

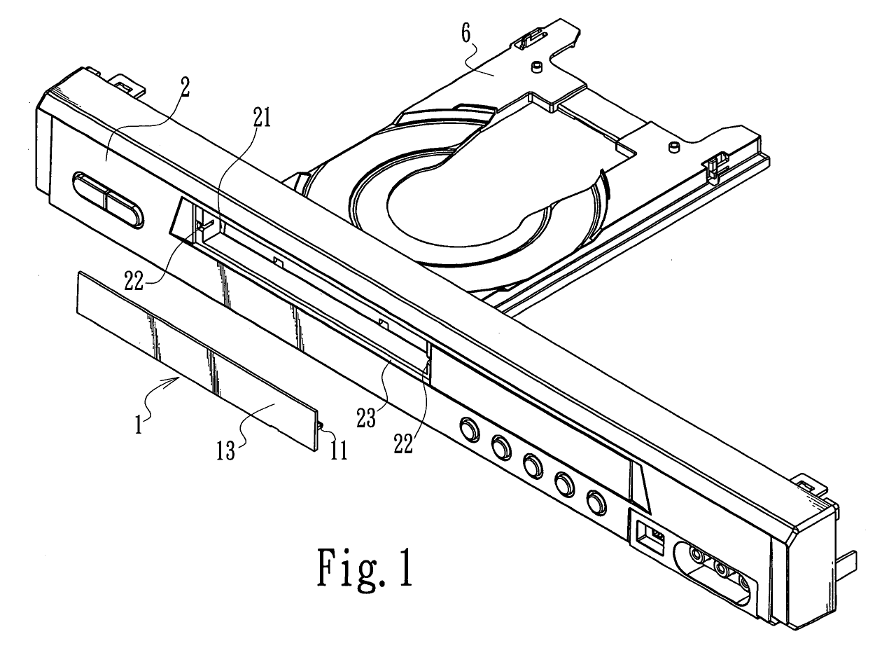

First please refer to FIG. 1. FIG. 1 is a perspective view showing one embodiment of the tray door guiding mechanism for optical disc device according to the present invention. The optical disc device has a disc tray 6. The tray door guiding mechanism includes a tray door 1 and a front panel 2. The front panel 2 is provided with a tray in-out window 21 for allowing the disc tray 6 to carry into/out from the optical disc device, the left and right sides of the tray in-out window are each provided with a guiding trench 22. The tray door 1 is provided in front of the disc tray 6 and the left and right sides of the tray door 1 are each provided with a guiding rib 11. The guiding ribs 11 are exactly guided into the guiding trenches 22 when the tray 6 is carried into the optical disc device.

The tray door 1 is loosely assembled with the disc tray 6, i.e. the tray door 1 is slightly moveable relative to the disc tray 6. When the disc tray 6 enters into the optical disc device, since the guiding ribs 11 are intended to be guided exactly into the guiding trenches 22, the tray door 1 is thus moved to an appropriate position to allow the tray door 1 being exactly inserted into the front panel 2 without interference with each other.

Moreover, a guiding angle 12 is provided on the end of the guiding rib 11 to provide a tolerance for guiding the guiding rib 11 exactly into the guiding trench 22 during carrying the tray door 1 into the optical disc device.

The tray door 1 further includes a tray door panel 13. A recess 23 for accommodating the tray door panel 13 is further provided in the outer portion of the tray in-out window 21. When the disc tray 6 enters into the optical disc device completely, the tray door panel 13 is completely accommodated in the recess 23 to allow the surface of the tray door panel 13 being at the same plane with the surface of the front panel 2.

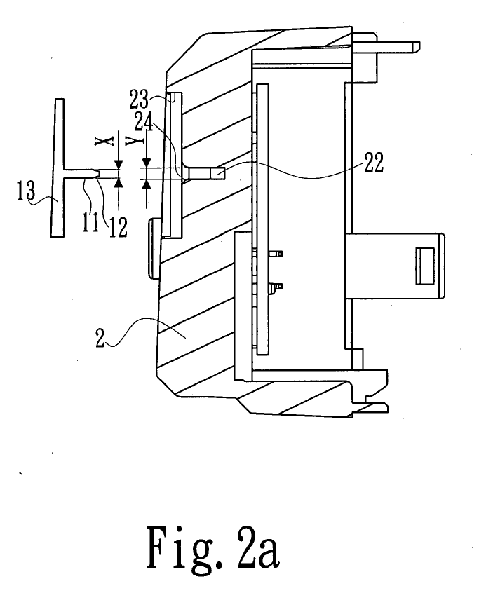

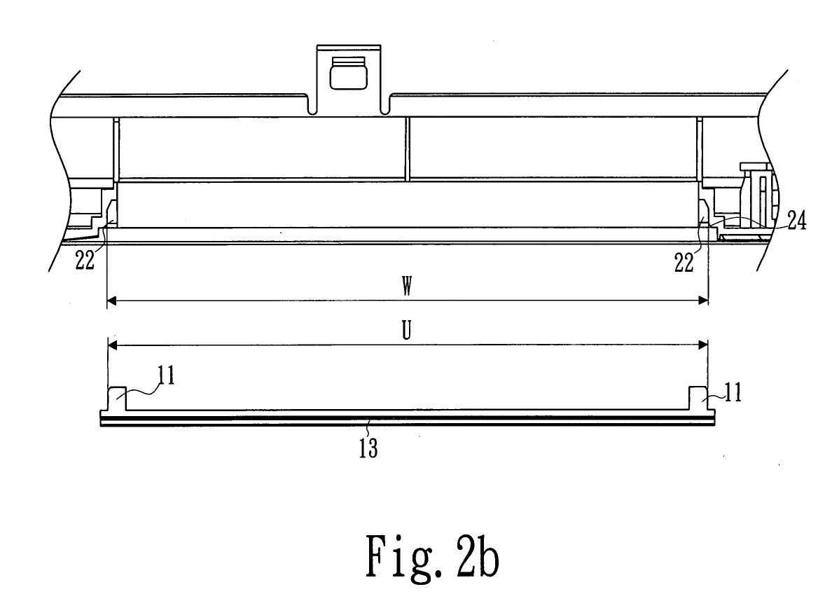

Next please refer to FIGS. 2a-2b. FIG. 2a is a side sectional view showing the tray door guiding mechanism shown in FIG. 1. If the height of the guiding rib 11 is set as X and the height of the guiding trench 22 is set as Y, then the deviation in longitudinal direction between the edge of tray door panel 13 and the edge of the recess 23 after guiding is being Y-X. FIG. 2b is a top sectional view partially showing the tray door guiding mechanism shown in FIG. 1. If the distance between the guiding trenches 22 provided in the left and right sides of the tray in-out window 21 excluding the width of the guiding angle 24 is set as W and the distance between the guiding ribs 11 provided in the tray door 1 including the width of the guiding ribs 11 is set as U, then the deviation in horizontal direction between the edge of tray door panel 13 and the edge of the recess 23 after guiding is being W-U. By adjusting the tolerance or gap between the guiding rib 11 and guiding trench 22, it is easy to control the gap between the edge of tray door panel 13 and the edge of the recess 23 in a desired range. The guiding rib 11 is extended form the inner surface of the tray door panel 13, and the guiding rib 11 is parallel to the guiding trench 22, both of which are also parallel to the direction that the disc tray moves into/out from the optical disc device.

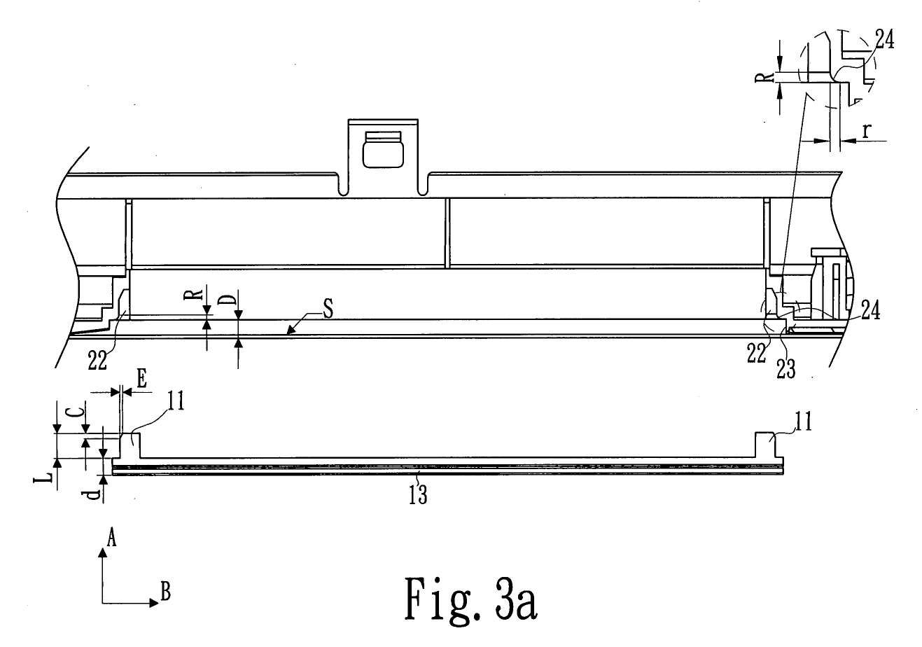

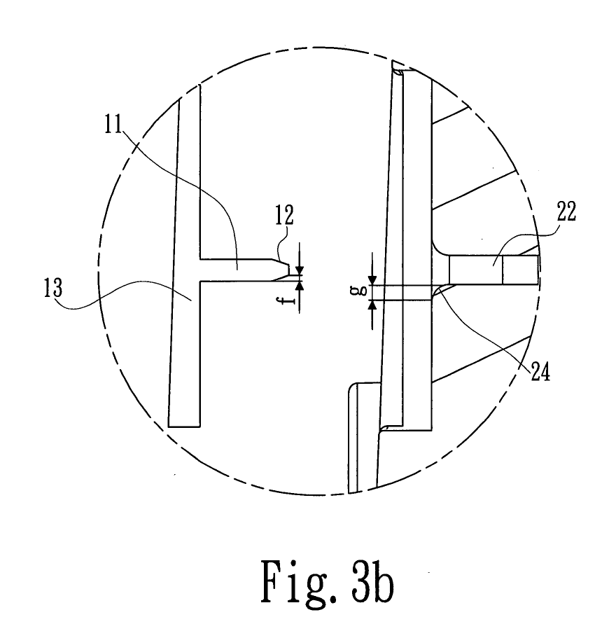

Please also refer to FIGS. 3a-3b. FIG. 3a is a top sectional view partially showing the tray door guiding mechanism shown in FIG. 1, in which the point S represents the position where a stage difference between tray door 1 and front panel 2 is happened. According to the tray door guiding mechanism of the present invention, if the depth of the recess 23 for accommodating the tray door is set as D and the thickness of the tray door panel 13 is set as d, then the surface of the tray door panel 13 after the tray completely entering into the optical disc device is at the same plane with the surface of the front panel 2 if D=d. When the depth of the recess 23 for accommodating the tray door is set as D, the length in longitudinal direction of the guiding angle 12 of the guiding rib 11 is set as C, and the length in longitudinal direction of the guiding angle 24 of the guiding trench 22 is set as R, then the length of the guiding rib 11 provided in the tray door 1 is being more than D+C+R. In this regard, when the disc tray 6 enters into optical disc device, the guiding rib 11 would guide the tray door panel 13 exactly into the recess 23 before generating inference between the tray door 1 and the front panel 2. The term “longitudinal direction” used herein means the direction of arrow A shown in FIG. 3a.

Furthermore, the deviation in traverse direction between the edge of tray door panel 13 and the edge of the recess 23 is less than E+r, in which E represents the length in traverse direction of the guiding angle of the guiding rib 11 and r represents the length in traverse direction of the guiding angle of the guiding trench 22. The term “traverse direction” used herein means the direction of arrow B shown in FIG. 3a.

FIG. 3b is a side sectional view partially showing the tray door guiding mechanism shown in FIG. 1. If the length in vertical direction of the guiding angle 12 of the guiding rib 11 is set as f and the length in vertical direction of the guiding angle 24 of the guiding trench 22 is set as g, then the deviation in vertical direction between the edge of tray door panel 13 and the edge of the recess 23 is less than f+g.

The more the length of the guiding angles in either longitudinal or vertical direction provided in guiding rib 11 and guiding trench 22, the more the tolerance in either longitudinal or vertical direction between the edge of tray door panel 13 and the edge of the recess 23 that the guiding mechanism can overcome.

Therefore, the tolerance caused by the assembling of the disc tray is easily overcome by designing the length of the guiding rib, the guiding trench, and the guiding angle according to the relation between them.

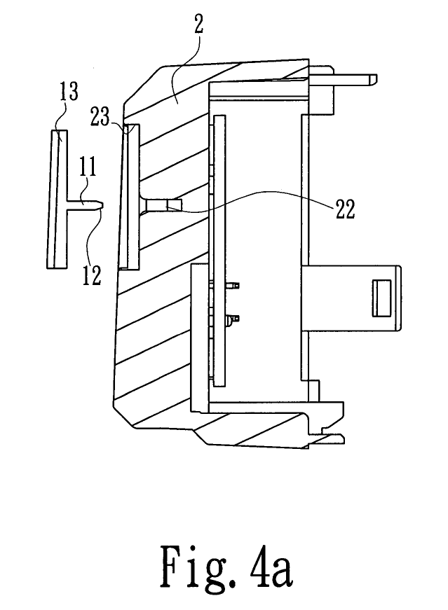

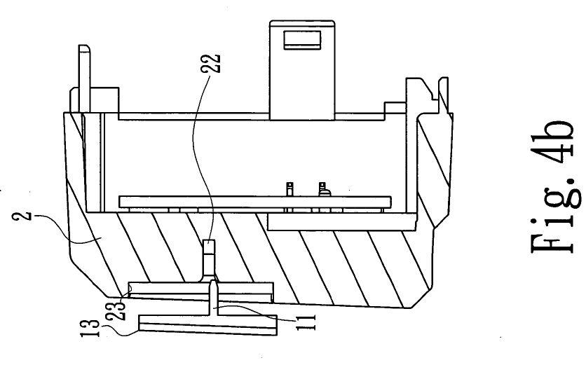

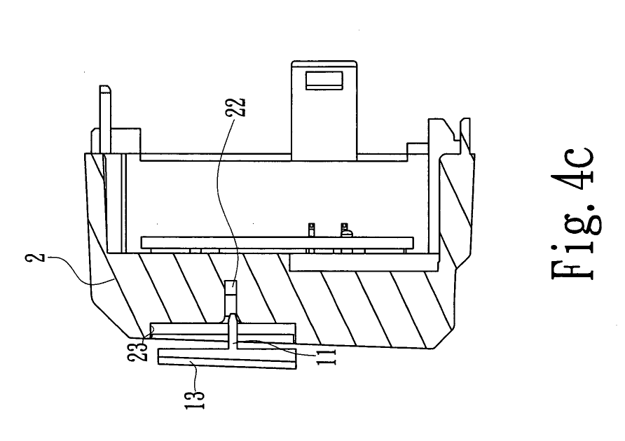

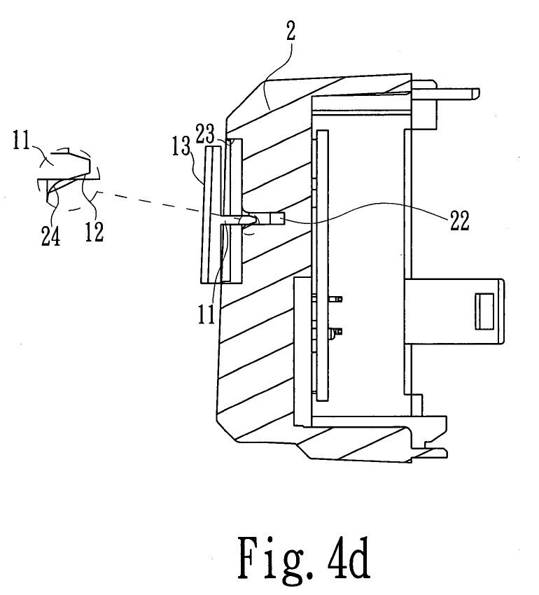

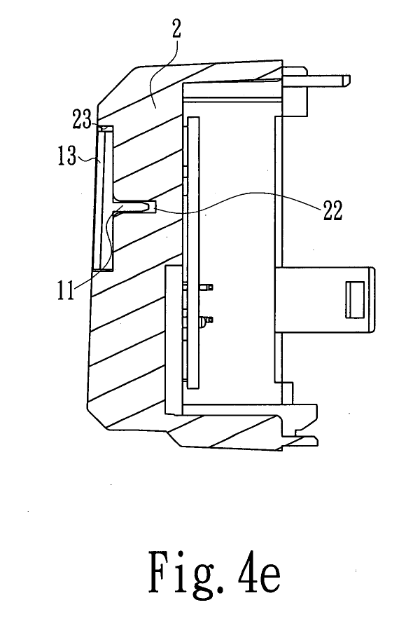

Next please refer to FIG. 4. FIGS. 4a-4e are flow charts showing how the tray door guiding mechanism of the present invention to guide the tray door. From FIG. 4a, it is shown that the tray door 1 is intended to enter into optical disc device, and the lower edge of the tray door panel 13 is lower than the lower edge of the tray in-out window 21, the lower edge of the tray door panel 13 will cause interference with the front panel 2. Then as shown in FIG. 4b, prior to causing the interference, the guiding rib 11 begins to contact with the guiding trench 22. Next as shown in FIG. 4c, due to the guiding angles 12 and 24 provided in the guiding rib 11 and guiding trench 22, respectively, the guiding angle 12 contact the guiding angle 24 and thus the tray door 1 is lifted to guide the tray door panel exactly inserting into the recess 23. Also as shown in FIG. 4d, the guiding function is completed and the interference between the tray door 1 and the front panel 2 is released. Finally as shown in FIG. 4e, by using the guiding mechanism of the present invention, the tray door panel 13 inserts into the recess 23 in a correct position and the surface of the tray door panel 13 is at the same plane with the surface of the front panel 2 after completing the entrance.

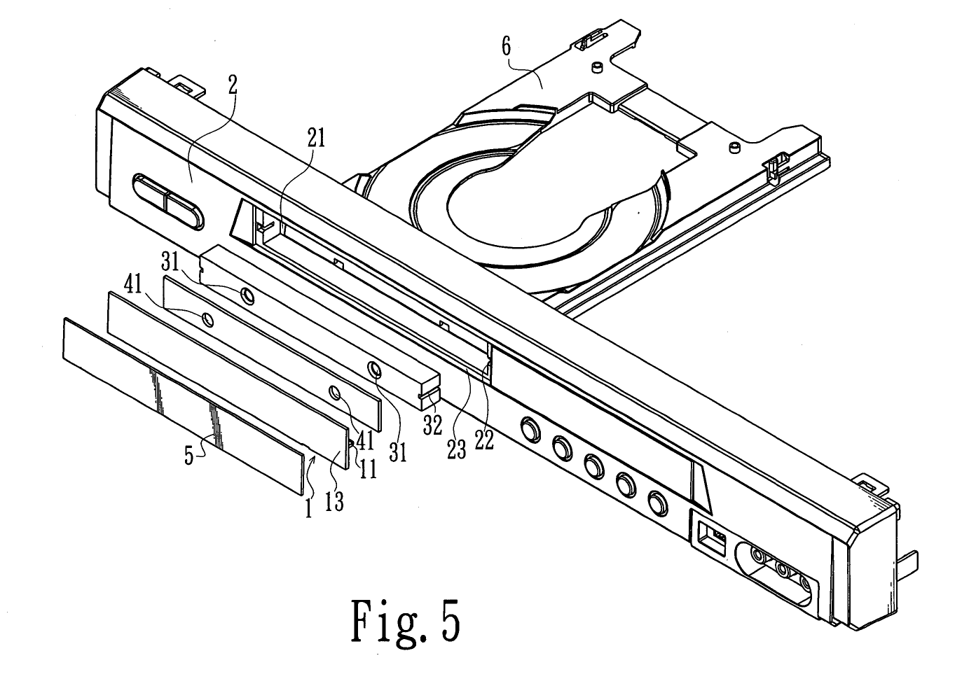

Finally, please refer to FIG. 5. FIG. 5 is a perspective view showing another embodiment of the tray door guiding mechanism for optical disc device according to the present invention. In this embodiment, the guiding mechanism includes a tray door 1, a front panel 2, a tray mount 3, and a buffer panel 4. The left and right sides of the tray door 1 are each provided with a guiding rib 11. The front panel 2 is provided with a tray in-out window 21 for allowing the disc tray 6 to carry into/out from the optical disc device, the left and right sides of the tray in-out window 21 are each provided with a guiding trench 22. The tray mount 3 is provided in front of the disc tray 6 and provided with several screw holes 31. The buffer panel 4 is also provided with several screw holes 41 correspondingly. By screwing a screw (not shown in the Figure) through the screw holes 31 and 41, the tray door 1 is fixed together with the tray mount 3 and the buffer panel 4. The tray mount 3 is fixed on the front of the disc tray 6, and the tray door 1 is assembled on the disc tray 6 through the tray mount 3. The buffer panel 4 is disposed between the tray door 1 and the tray mount 3 for absorbing the vibration between them. Also, a trench 32 for accommodating part of the guiding rib 11 is provided in the tray mount 3 corresponding to the guiding rib 11 of the tray door 1.

Furthermore, the diameter of the screw holes 31 and 41 provided on the tray mount 3 and buffer panel 4 is larger than the diameter of the screw to be screwed, so that the tray door 1 is allowed to move in up, down, right, and left directions relative to the tray mount 3 and the buffer panel 4 corresponding to the movement of the guiding rib 11.

According to the guiding mechanism of the present invention, a decorative panel 5 is further provided on outer surface of the tray door panel 13 to give the optical disc device an ornamental function and variability.

According to the tray door guiding mechanism for optical disc device of the present invention, by interaction between the guiding trench on the front panel and the guiding rib on the tray door, an effect for guiding the tray door exactly is attainable. Therefore, the gap between the tray door and the front panel is controllable by adjusting the tolerance between the guiding rib and the guiding trench. Also, the assembling error between the tray door and the front panel is modified to avoid the tray door being interfered with the front panel during carrying the tray into the optical disc device. Therefore, the tray is smoothly carried into the device and yields a uniform gap between the tray door and the front panel of the optical disc device.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A tray door guiding mechanism for an optical disc device, in which the optical disc device has a disc tray for carrying a disc, the guiding mechanism comprises:
a front panel, which is provided with a tray in-out window for allowing the disc tray to carry into/out from the optical disc device, in which at least one side of the tray in-out window is provided with a guiding trench;
a tray door provided in front of the disc tray, in which at least one side of the tray door is provided with a guiding rib;
whereby the guiding rib is guided in the guiding trench when the tray is carried into the optical disc device.

2. The tray door guiding mechanism according to claim 1, wherein the tray door is loose fitted with the disc tray.

3. The tray door guiding mechanism according to claim 1, wherein the tray door further comprises a tray door panel, and the guiding rib is extended form the inner surface of the tray door panel, and a recess for accommodating the tray door panel is further provided in the outer portion of the tray in-out window.

4. The tray door guiding mechanism according to claim 3, wherein the length of the guiding rib is larger than the depth of the recess for accommodating the tray door panel.

5. The tray door guiding mechanism according to claim 1, wherein the guiding rib and the guiding trench are further respectively provided with a guiding angle.

6. The tray door guiding mechanism according to claim 5, wherein the length of the guiding rib provided in tray door 1 is being more than D+C+R, in which D represents the depth of the recess, C represents the length in longitudinal direction of the guiding angle of the guiding rib, and R represents the length in longitudinal direction of the guiding angle of the guiding trench.

7. The tray door guiding mechanism according to claim 3, wherein the deviation in traverse direction between the edge of tray door panel and the edge of the recess is less than E+r, in which E represents the length in traverse direction of the guiding angle of the guiding rib and r represents the length in traverse direction of the guiding angle of the guiding trench.

8. The tray door guiding mechanism according to claim 3, wherein the deviation in vertical direction between the edge of tray door panel and the edge of the recess is less than f+g, in which f represents the length in vertical direction of the guiding angle of the guiding rib and g represents the length in vertical direction of the guiding angle of the guiding trench.

9. The tray door guiding mechanism according to claim 1, which further comprises a tray mount provided in front of the disc tray for connecting the tray and the tray door.

10. The tray door guiding mechanism according to claim 9, wherein the tray mount is provided with at least one screw hole and the tray door is assembled with the tray mount by inserting a screw into the screw hole, and the diameter of the screw hole is larger than that of the screw so that the tray door is moved corresponding to the movement of the guiding rib when it is guided by the guiding trench.

11. The tray door guiding mechanism according to claim 9, wherein a trench for accommodating part of the guiding rib is further provided in the tray mount.

12. The tray door guiding mechanism according to claim 9, wherein a buffer panel is further provided between the tray door and the tray mount.

13. The tray door guiding mechanism according to claim 9, wherein a decorative panel is further provided on outer surface of the tray door.
